(19) United States
(12) Patent Application Publication
(10) Pub. No.: US 2010/0320882 A1
(43) Pub. Date: Dec. 23, 2010

(54) PORTABLE ELECTRONIC DEVICE

(75) Inventor: BIN ZHANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/634,802

(22) Filed: Dec. 10, 2009

(30) Foreign Application Priority Data
Jun. 19, 2009 (CN) 200910303463.4

(51) Int. Cl. A47B 81/00; A47B 97/00; F21V 3/00

(52) U.S. Cl. 312/204; 362/311.13

(57) ABSTRACT

A portable electronic device includes a housing, a cover, and a decorative member. The cover is detachably assembled to the housing, and includes an at least partially transparent main panel. The decorative member is detachably assembled to the cover and is viewable through the main panel.

### BACKGROUND

1. Technical Field

The present disclosure relates to portable electronic devices, and particularly to a portable electronic device having a changeable appearance.

2. Description of Related Art

Portable electronic devices, such as mobile phones, personal digital assistants (PDA), and laptop computers, are widely used. Besides high quality and multiple functions, these portable electronic devices are often required to provide varying appearances. Thus, many decorative means are often used in the portable electronic devices.

Many portable electronic device use changeable batteries to supply electric power and have detachable battery covers mounted thereon to secure and protect the batteries. A battery cover may cover much area of the outside surface of a portable electronic device. Generally, little decorative means are used for the battery covers, which may adversely affect the appearances of the portable electronic devices.

Therefore, there is room for improvement within the art.

### BRIEF DESCRIPTION OF THE DRAWINGS

Many aspects of the present portable electronic device can be better understood with reference to the following drawings. The components in the various drawings are not necessarily drawn to scale, the emphasis instead being placed upon clearly illustrating the principles of the present portable electronic device. Moreover, in the drawings, like reference numerals designate corresponding parts throughout the figures.

FIG. 1 is an assembled view of a portable electronic device, according to a first exemplary embodiment.

FIG. 2 is a disassembled view of the portable electronic device shown in FIG. 1.

FIG. 3 is similar to FIG. 2, but shown from another viewing angle.

FIG. 4 is a disassembled view of a portable electronic device, according to a second exemplary embodiment.

### DETAILED DESCRIPTION

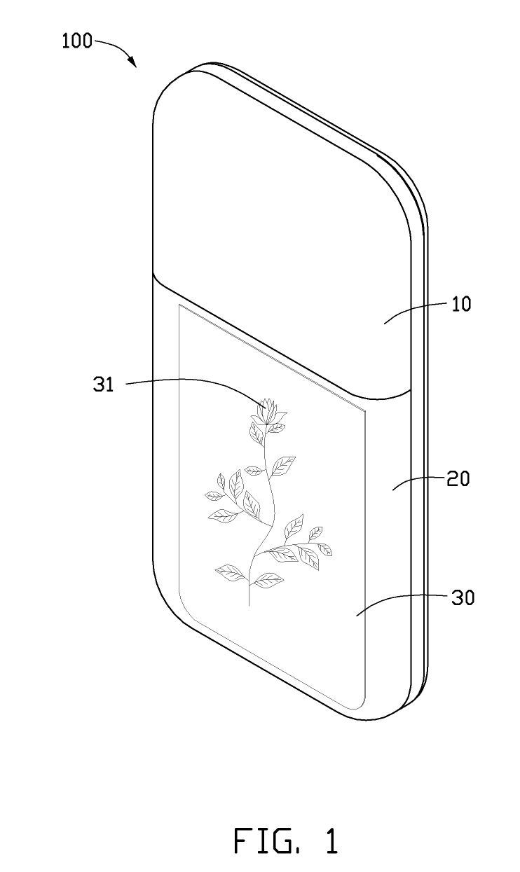

FIG. 1 shows a portable electronic device 100, according to a first exemplary embodiment. The portable electronic device 100 can be a mobile phone, a personal digital assistant (PDA), an MP3/MP4 player, etc. The portable electronic device 100 includes a housing 10, a battery cover 20 and a changeable decorative member 30. The battery cover 20 is detachably assembled to the housing 10, and the decorative member 30 is detachably assembled to the battery cover 20.

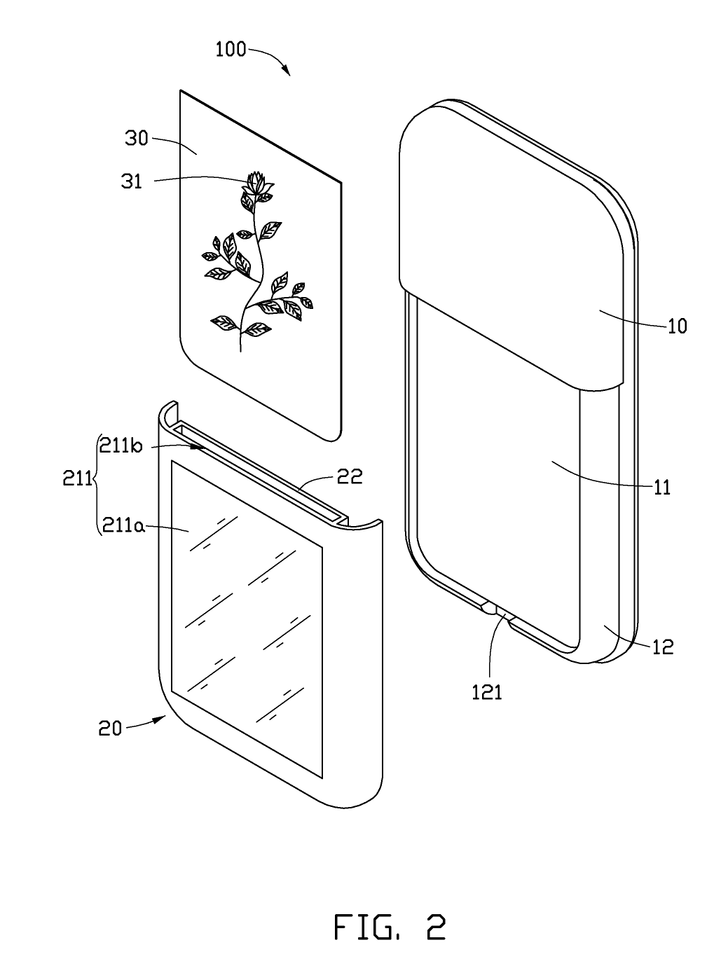

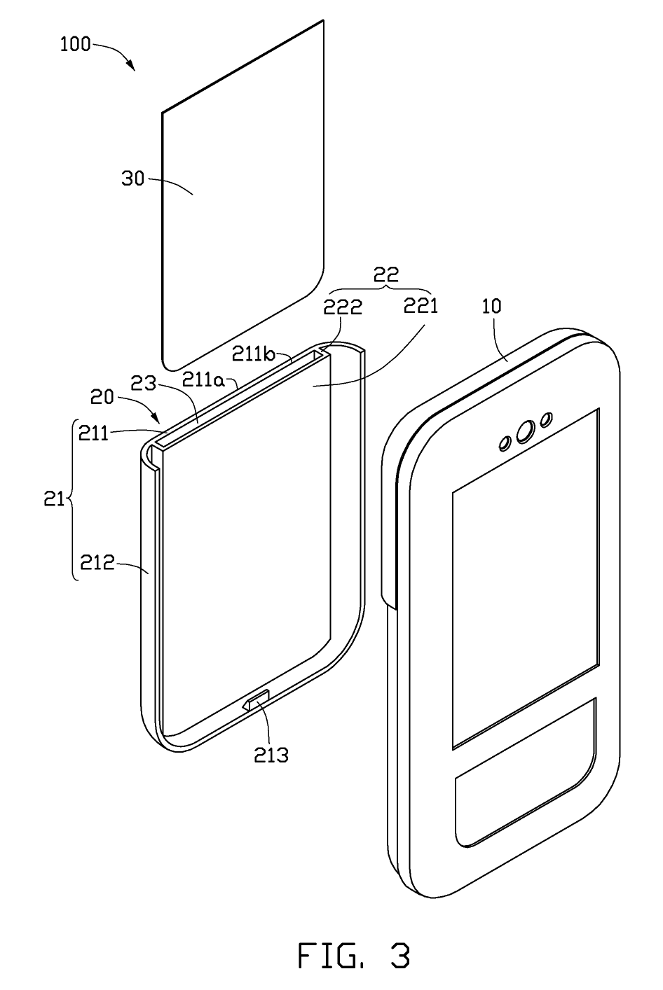

Referring to FIG. 2 and FIG. 3, the housing 10 is a conventional housing of the portable electronic device 100. An outside surface of the housing 10 is partially recessed to form an assembly portion 12, and the assembly portion 12 defines a receiving groove 11 in a central portion thereof. In use, the receiving groove 11 can receive a conventional battery (not shown) of the portable electronic device 100. The assembly portion 12 further defines an assembly groove 121 on an end thereof.

The battery cover 20 includes a cover member 21 and a case member 22. The cover member 21 includes a main panel 211 and an assembly frame 212. The main panel 211 is a rectangular planar sheet made of at least partially transparent materials (i.e., ranging from at least partially transparent to fully transparent), of shape and size corresponding to the receiving groove 11. The main panel 211 includes a first surface 211a and an opposite second surface 211b. The main panel 211 has two parallel sides and an end between the two sides all extend approximately perpendicularly to the first surface 211a, thereby forming the assembly frame 212. Thus, the assembly frame 212 is configured to be U-shaped and is connected to the periphery of the first surface 211a. An inner shape of the assembly frame 212 is configured to correspond to the outer shape of the assembly portion 12. Thus, the assembly frame 212 can engage the assembly portion 12 to assemble the battery cover 20 to the housing 10, and the main panel 211 can cover the receiving groove 11. A retaining protrusion 231 corresponding to the assembly groove 121 is formed on an inside surface of the assembly frame 212. The retaining protrusion 231 can be held in the assembly groove 121 to secure the battery cover 20 on the housing 10.

The case member 22 includes a case panel 221 and a connecting frame 222. The case panel 221 is a rectangular planar sheet, of shape and size similar to the main panel 211. The case panel 221 has two parallel sides and an end between the two sides of the main panel 211 all perpendicularly extending towards a same side, thereby forming the connecting frame 222. Thus, the connecting frame 212 is configured to be U-shaped and is perpendicularly connected to the periphery of a surface of the case panel 221. The connecting frame 222 is perpendicularly fixed on the second surface 211b of the main panel 211. Thus, the main panel 211 and the case panel 221 are assembled together and parallel to each other, and a containing space 23 is formed between the main panel 211 and the case member 22. Further, the positions of the case panel 221 and the connecting frame 222 correspond to the receiving groove 11. When the battery cover 20 is assembled to the housing 10, the case panel 221 and the connecting frame 222 can be received in the receiving groove 11.

The decorative member 30 is a planar sheet having predetermined decorative patterns 31 formed thereon. The decorative member 30 can be received in the containing space 23.

During assembly, the decorative member 30 is received in the containing space 23, and the decorative patterns 31 are positioned facing the main panel 211. The battery cover 20 is assembled to the housing 10. Thus, the decorative patterns 31 are visible through the at least partially transparent main panel 211, enhancing the appearance of the portable electronic device 100. Further, the decorative member 30 can be removed or replaced when the battery cover 20 is separated from the housing 10. Thus, the portable electronic device 100 can provide varying appearance when the battery cover 20 is reassembled to the housing 10.

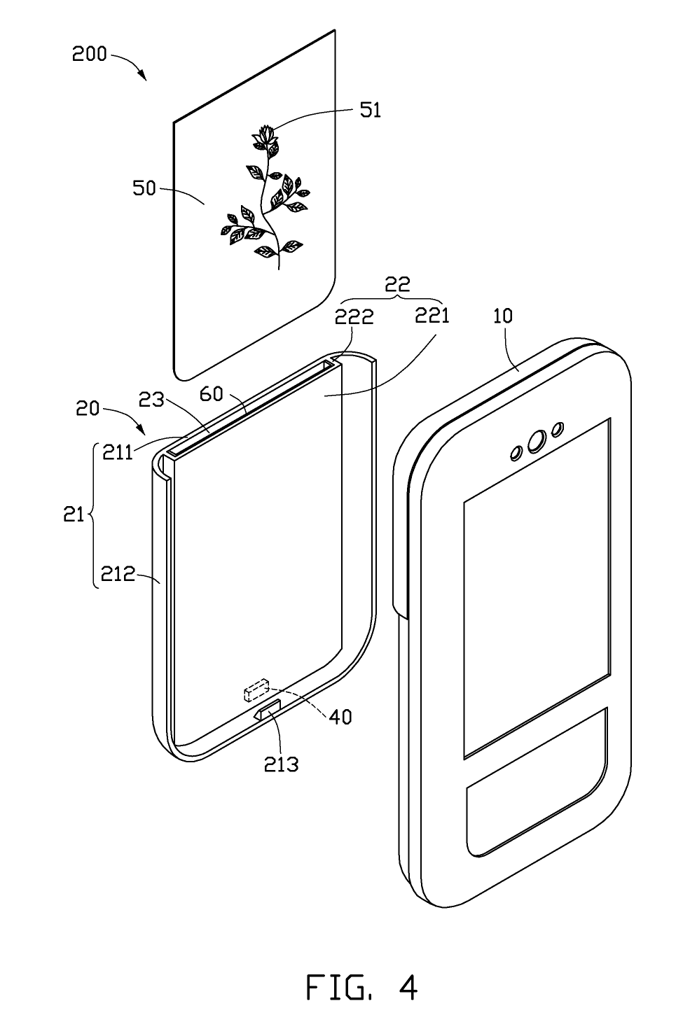

FIG. 4 shows a portable electronic device 200, according to a second exemplary embodiment, differing from the previous embodiment by inclusion of a light emitting member 40, a changeable decorative member 50 and a reflective layer 60.

The light emitting member 40 can be a light emitting diode (LED) or other conventional light emitting component. The light emitting member 40 is received in the containing space 23 or embedded in the case panel 221. When the battery cover 20 is assembled to the housing 10, the light emitting member 40 can be electrically connected to inner circuits (not shown) of the portable electronic device 200 by conventional means. Thus, the light emitting member 40 can be controlled (e.g., turning on/off the light emitting member 40, or regulating the luminous/colors of light emitted by the light emitting member 40) by operations on the portable electronic device 200.

The decorative member 50 is a planar sheet made of at least partially transparent materials. Predetermined decorative patterns 51 are formed on/in the decorative member 50. The decorative patterns 51 can also be at least partially transparent, and the colors of the decorative patterns 51 are different from the background color of the decorative member 50. The decorative member 50 can be received in the containing space 23. The reflective layer 60 is made of material or other conventional reflective materials. The reflective layer 60 is formed on a surface of the case panel 221 positioned towards the main panel 211, i.e., the inner surface of the case panel 221.

During assembly, the decorative member 50 is received in the containing space 23, and is positioned between the light emitting member 40 and the main panel 211. The battery cover 20 is assembled to the housing 10. Thus, the decorative patterns 51 are visible through the main panel 211, enhancing the appearance of the portable electronic device 200. When the light emitting member 40 emits light, which passes through the decorative member 50 and the main panel 211, the appearance of the portable electronic device 200 is further enhanced. The reflective layer 60 reflects light arriving at the inner surface of the case panel 221, such that the light returns and passes through the decorative member 50 and the main panel 211. Thus, the working efficiency of the light emitting member 40 is increased. Additionally, the light passing through the decorative member 50 can project the decorative patterns 51, which enhances overall performance the portable electronic device 200.

In the present disclosure, the battery cover 20 of the portable electronic device 100/200 displays or projects varying decorative patterns, enhancing appearance of the portable electronic device 100/200.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A portable electronic device, comprising:
a housing;
a cover detachably assembled to the housing, the cover including an at least partially transparent main panel; and
a decorative member detachably assembled to the cover and viewable through the main panel.

2. The portable electronic device as claimed in claim 1, wherein decorative patterns are formed on the decorative member and viewable through the main panel.

3. The portable electronic device as claimed in claim 1, wherein the decorative member is changeable.

4. The portable electronic device as claimed in claim 1, wherein the cover further includes a case member connected to the main panel, a containing space is formed between the main panel and the case member, and the decorative member is received in the containing space.

5. The portable electronic device as claimed in claim 4, wherein the decorative member is at least partially transparent, and decorative patterns are formed on/in the decorative member.

6. The portable electronic device as claimed in claim 5, wherein the decorative patterns are at least partially transparent, and the colors of the decorative patterns are different from the background color of the decorative member.

7. The portable electronic device as claimed in claim 5, further comprising a light emitting member received in the containing space, the decorative member positioned between the light emitting member and the main panel.

8. The portable electronic device as claimed in claim 7, wherein the light emitted by the light emitting member passes through the decorative member and the main panel.

9. The portable electronic device as claimed in claim 5, further comprising a reflective layer formed on the case member, the reflective layer reflecting the light emitted by the light emitting member to pass through the decorative member and the main panel.
